(19) United States
(12) Patent Application Publication
(10) Pub. No.: US 2013/0195078 A1
(43) Pub. Date: Aug. 1, 2013

(54) COMMUNICATION SYSTEM, MOBILE TERMINAL, AND COMMUNICATION METHOD

(71) Applicants: Hirokazu Kobayashi, Osaka-shi (JP); Shinichi Sawada, Osaka-shi (JP); Shigeto Suzuki, Osaka-shi (JP); Koki Suzuki, Osaka-shi (JP); Akio Yoshihara, Osaka-shi (JP)

(72) Inventors: Hirokazu Kobayashi, Osaka-shi (JP); Shinichi Sawada, Osaka-shi (JP); Shigeto Suzuki, Osaka-shi (JP); Koki Suzuki, Osaka-shi (JP); Akio Yoshihara, Osaka-shi (JP)

(73) Assignee: SHARP KABUSHIKI KAISHA, Osaka-shi, Osaka (JP)

(21) Appl. No.: 13/878,834

(22) PCT Filed: Nov. 29, 2011
(86) PCT No.: PCT/JP2011/077488

§ 371 Date: Apr. 11, 2013

(30) Foreign Application Priority Data
Nov. 30, 2010 (JP) 2010-266918

(51) Int. Cl. H04W 36/16

(52) U.S. Cl. CPC H04W 36/165
USPC 370/331

(57) ABSTRACT

A wireless communication system including a mobile terminal and a plurality of base stations is provided. Each of base stations includes communication unit selectively uses at least one of a plurality of frequency bands to communicate with the mobile terminal, and a handover unit performs handover with at least one another base station. The mobile terminal includes a storage unit stores, by each base station basis, information of a frequency band used for communication from the plurality of frequency bands, and a notification unit notifies, when handover from a first base station currently connected in communication to a second base station is required, the first base station about a proximity indication associated with some of the plurality of frequency bands based on the stored information of the frequency band used for communication.

### TECHNICAL FIELD

The present invention relates to a wireless communication system including a mobile terminal and a plurality of base stations, a mobile terminal directed to the system, and a communication method at the system. Particularly, the present invention relates to a configuration in which a base station selectively uses at least one of a plurality of frequency bands to communicate with a mobile terminal.

### BACKGROUND ART

Currently, 3GPP (Third Generation Partnership Project) is now moving towards introducing a Home evolved Node B (hereinafter, also referred to as “HeNB”) in addition to the general evolved Node B (hereinafter, also referred to as “eNB”) in LTE (Long Term Evolution) that is the next generation communication scheme and in LTE-A (LTE-Advanced) that is an advanced version of LTE. The HeNB is directed to enlarging the service area and is for individual use.

According to the standards that are now being developed in 3GPP, the cell provided by a HeNB is intended to include three types of cells, namely (1) open cell; (2) CSG (Closed Subscriber Group) cell; and (3) hybrid cell. (1) The open cell can be connected by all users. (2) The CSG cell allows connection with only a specific user. (3) The hybrid cell includes the features of both the open cell and CSG cell.

The method of handover that will occur in the case where a mobile terminal (User Equipment: hereinafter also referred to as “UE”) moves between a cell provided by a HeNB and a cell provided by an eNB (hereinafter, also referred to as “macro cell” to distinguish from a cell provided by a HeNB) has already being determined (Non-Patent Document 1).

Non-Patent Document 1 describes the standardization specification for inbound handover to a HeNB. Non-Patent Document 1 discloses the processing when a HeNB is selected as the handover destination when UE is currently connected in communication with any eNB (macro cell). Specifically, UE maintains an allowed CSG list (Allowed CSG List) describing the identification information of cells (CSG_ID) that are allowed to connect with the UE itself. In the stage of preparing for a handover operation, UE transmits proximity information (proximity indication) to the network, when (i) UE determines that a HeNB having identification information identical to any of CSG_IDs described in the allowed CSG list maintained at the host station is located nearby, or when (ii) UE determines exit from the nearby area of a HeNB. By this processing, UE can request the base station for inter-frequency_measurement setting.

The proximity indication includes: (i) frequency information corresponding to “enter” indicating an approach to a HeNB having identification information identical to any of CSG_IDs described in the allowed CSG list maintained by UE; or (ii) “leave” indicating departure from a HeNB (Non-Patent Document 2).

Namely, the proximity indication is the information notified to eNB by UE when UE determines approach of a new HeNB capable of connection by handover from eNB (macro cell), or when UE determines departure from a HeNB.

In 3GPP, introduction of carrier aggregation for LTE-A is now being studied. Carrier aggregation is the technique to enlarge the maximum transmission bandwidth that can be supported from 20 MHz that is the maximum transmission bandwidth of LTE up to 100 MHz. In order to support such a bandwidth of 100 MHz, usage of a plurality of component carriers corresponding to 20 MHz that is the maximum transmission bandwidth of LTE to carry out data transmission and reception between a mobile terminal and a base station is anticipated.

### CITATION LIST

### Non Patent Document

NPD 1: 3GPP Organizational Partners, “3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 10)”, 3GPP TS 36. 300 V10. 0. 0 (2010-06), Section 10. 5. 1.2
NPD 2: “3GPP Organizational Partners, “3rd Generation Partnership Project; Technical Specification Group Radio Access Network; Evolved Universal Terrestrial Radio Access (E-UTRA); Radio Resource Control (RRC); Protocol specification (Release 9)”, 3GPP TS 36. 331 V9. 3.0 (2010-06), Section 5. 3. 14
NPD 3: Panasonic, “Proximity indication for multiple CSG or Hybrid cells”, 3GPP TSG-RAN WG2 Meeting #69 R2-101078, San Francisco, USA, 22-26 Feb., 2010

### SUMMARY OF INVENTION

### Technical Problem

In view of supporting carrier aggregation at a HeNB according to 3GPP Release 10, it is anticipated that each HeNB will provide a plurality of cells having different frequency bands. Under the anticipation of such a configuration, a plurality of proximity indications will be transmitted onto the network for every frequency band with respect to a plurality of cells associated with each frequency band provided by a HeNB. As a result, the radio resource of the network will be consumed uselessly.

During inbound handover to a HeNB supporting carrier aggregation, a proximity indication will be transmitted onto the network. If a proximity indication is transmitted for each of the present cells for every frequency band, the amount of radio signals in the band will increase unnecessarily due to the notification of the plurality of proximity indications.

To solve a similar problem, Non-PTD 3 proposes the approach of sending only one proximity indication from the mobile terminal. If such an approach can be realized, the consumed amount of the radio resource can be suppressed to approximately the level of LTE even in the case where the aforementioned configuration is employed in LTE-A. However, narrowing down the frequency band from a plurality of frequency bands for transmission of the proximity indication has not been determined at all. Furthermore, even if the transmission destination of the proximity indication is selected to one cell, the method of selection thereof is not yet determined.

In view of the foregoing, an object of the present invention is to provide, in a wireless communication system including a plurality of base stations selectively using at least one of a plurality of frequency bands for communication, a communication system, a mobile terminal, and a communication method allowing the amount of consumed radio resource to be suppressed while maintaining a stable handover operation.

### Solution to Problem

According to an embodiment of the present invention, there is provided a wireless communication system including a mobile terminal and a plurality of base stations. Each of the base stations includes communication means for selectively using at least one of a plurality of frequency bands to communicate with the mobile terminal, and handover means for performing handover with at least one another base station. The mobile terminal includes storage means for storing, by each base station basis, information of a frequency band used for communication from the plurality of frequency bands, and notification means for notifying, when handover from a first base station currently connected in communication to a second base station is required, the first base station about a proximity indication associated with some of the plurality of frequency bands, based on the stored information of a frequency band used for communication. The handover means initiates handover based on the proximity indication from the mobile terminal.

Preferably, the storage means stores the information of the frequency band used for communication in association with time, and the notification means associates a frequency band used in a relatively recent communication among the communication between the mobile terminal and the second base station with the proximity indication.

Preferably, the storage means stores the information of the frequency band used for communication in association with a communication quality during the relevant communication, and the notification means associates a frequency band having a relatively higher communication quality from the frequency bands used for communication between the mobile terminal and the second base station with the proximity indication.

Preferably, the storage means determines priority for the plurality of frequency bands that can be used at a base station having carried out communication, and stores information of the base station having carried out communication and the frequency band used for the communication in association with a corresponding priority. The notification means associates a frequency band having a relatively higher priority with the proximity indication.

Preferably, the base station is configured to notify the mobile terminal about information indicating the priority of a plurality of frequency bands that can be used at the relevant base station. The notification means associates a particular frequency band with the proximity indication based on the information indicating priority.

According to another embodiment of the present invention, there is provided a mobile terminal used in a wireless communication system including a plurality of base stations adapted to selectively use at least one of a plurality of frequency bands to carry out communication. The mobile terminal includes storage means for storing, by each base station basis, information of a frequency band used for communication from the plurality of frequency bands, and notification means for notifying, when handover from a first base station currently connected in communication to a second base station is required, the first base station about a proximity indication associated with some of the plurality of frequency bands, based on the stored information of the frequency band used for communication.

Preferably, the storage means stores information of a base station having carried out communication and a frequency band used for the communication in association with time, and the notification means associates a frequency band used in a relatively recent communication among the communication between the mobile terminal and the second base station with the proximity indication.

Preferably, the storage means stores information of a base station having carried out communication and a frequency band used for the communication in association with a communication quality during the relevant communication, and the notification means associates a frequency band having a relatively higher communication quality, from the frequency bands used for communication between the mobile terminal and the second base station, with the proximity indication.

Preferably, the storage means determines priority for a plurality of frequency bands that can be used at the base station having carried out communication, and stores the base station having carried out communication and the frequency band used for communication in association with a corresponding priority. The notification means associates a frequency band having a relatively higher priority with the proximity indication.

Further preferably, the storage means assigns a relatively higher priority to a frequency band having a relatively higher communication quality during a previous communication, and updates the priority when a new communication connection is established.

Preferably, the storage means assigns a relatively higher priority to a frequency band having a relatively low frequency from the plurality of low frequency bands.

Preferably, the storage means determines the priority according to an operation external to the mobile terminal.

Preferably, the mobile terminal further includes reception means for receiving, from a base station, information indicating priority for a plurality of frequency bands that can be used at the relevant base station. The notification means associates a particular frequency band with the proximity indication based on the information indicating priority.

According to a further embodiment of the present invention, there is provided a communication method used at a wireless communication system including a plurality of base stations adapted to selectively use at least one of a plurality of frequency bands to carry out communication. The communication method includes the steps of: storing, by each base station basis, information of a frequency band used for communication from the plurality of the frequency bands; notifying, when handover from a first base device currently connected in communication to a second base station is required, the first base station about a proximity indication associated with some of the plurality of frequency bands, based on the stored information of a frequency band used for communication; and initiating handover based on the proximity indication.

### Advantageous Effects of Invention

According to the present invention, the consumed amount of radio resource can be suppressed while maintaining a stable handover operation at a wireless communication system including a plurality of base stations selectively using at least one of a plurality of frequency bands to communicate.

### BRIEF DESCRIPTION OF DRAWINGS

FIG. 1 schematically represents a configuration of a communication system envisaged in a first embodiment of the present invention.

FIG. 2 schematically represents a concept of carrier aggregation.

FIG. 3 is a block diagram of a mobile terminal (UE) used in the communication system according to the first embodiment of the present invention.

FIG. 4 represents an example of adjacent cell information retained by a mobile terminal according to the first embodiment of the present invention.

FIG. 5 represents an example of entered-cell frequency information retained by a mobile terminal according to the first embodiment of the present invention.

FIG. 6 is a block diagram of a base station used in the communication system according to the first embodiment of the present invention.

FIG. 7 is a flowchart of the processing procedure at a mobile terminal (UE) used in the communication system according to the first embodiment of the present invention.

FIG. 8 represents the sequence of a handover operation in the communication system according to the first embodiment of the present invention.

FIG. 9 is a block diagram of a mobile terminal (UE) used in a communication system according to a second embodiment of the present invention.

FIG. 10 represents an example of frequency priority information retained by a mobile terminal according to the second embodiment of the present invention.

FIG. 11 is a flowchart of the processing procedure at a mobile terminal (UE) used in the communication system according to the second embodiment of the present invention.

FIG. 12 is a block diagram of a mobile terminal (UE) used in a communication system according to a modification of the second embodiment of the present invention.

### DESCRIPTION OF EMBODIMENTS

Embodiments of the present invention will be described in detail hereinafter with reference to the drawings. In the drawings, the same or corresponding elements have the same reference characters allotted, and description thereof will not be repeated.

### First Embodiment

<1. System Configuration>

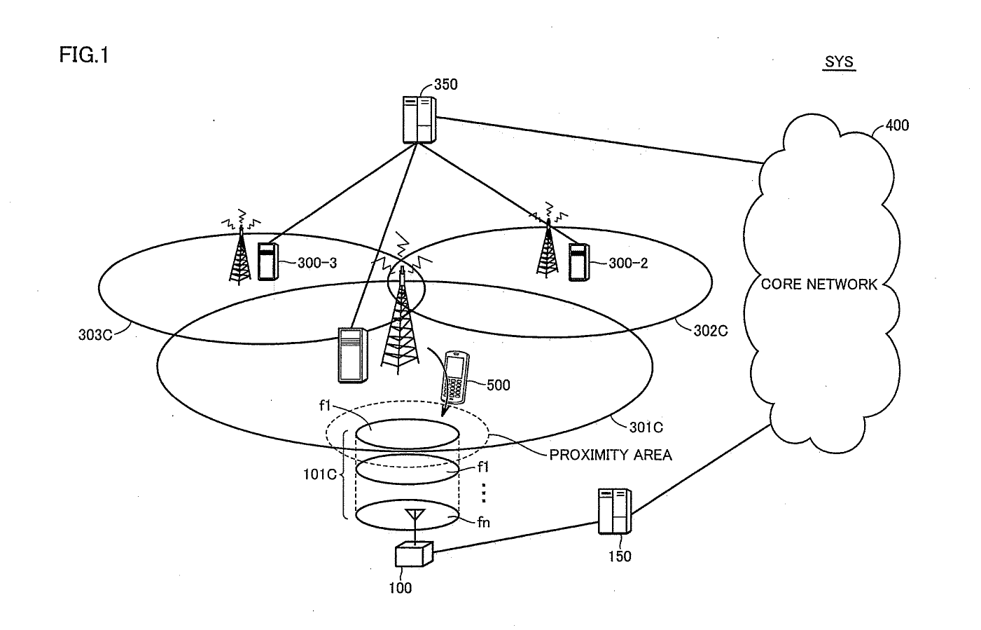

FIG. 1 schematically represents a configuration of a communication system SYS envisaged in the first embodiment of the present invention. As a typical example, communication system SYS is assumed to support a communication scheme according to the LTE scheme or LTE-A scheme.

Referring to FIG. 1, communication system SYS includes evolved Node B (hereinafter, also referred to as “eNB”) 300-1 to 300-3, and Home evolved node B (hereinafter, also referred to as “HeNB”) 100. eNB and HeNB may generically be referred to simply as “base station”. HeNB 100 covers a cell range 101C. eNBs 300-1 to 300-3 cover cell ranges 301C to 303C, respectively. The number of eNBs and HeNBs is set appropriately according to the system.

As mentioned above, introduction of HeNB is considered for the purpose of enlarging the service area and for individual use or the like at LTE and LTE-A. Therefore, cell range 101C of HeNB 100 is smaller than cell ranges 301C-303C of eNBs 300-1 to 300-3.

Each base station is connected with at least one gateway. Each gateway monitors the connection destination of a base station, and is connected to a core network 400 to build a wide area network. Accordingly, communication between mobile terminals (User Equipment: hereinafter also referred to as “UE”) present in different cell ranges is allowed. At least one base station (generally a plurality) is connected to each gateway. In the LTE scheme or LTE-A scheme, it is anticipated that core network 400 is a network where all information are set in packets.

More specifically, it is assumed that HeNB 100 is connected with a gateway 150, and eNBs 300-1 to 300-3 are connected with a gateway 350. The number of gateways and the topology are set appropriately according to the system.

Gateways 150 and 350 include a SAE gateway (System Architecture Evolution Gateway) function and mobility management entity (hereinafter, also referred to as “MME”) function. The SAE gateway function serves to route a user packet on core network 400. The MME function serves to control the setting/opening of a session (connection) for packet communication as well as handover (switching of base station).

UE 500 is generally carried by a user, moving among cells in accordance with the movement of the user. When UE 500 is located in any of the cell ranges, communication service is accepted through the base station and gateway managing the relevant cell. When this UE 500 moves from any of the cell ranges to another cell range, a handover operation is initiated.

<2. Carrier Aggregation>

It is assumed that the HeNB in communication system SYS of FIG. 1 incorporates the carrier aggregation function.

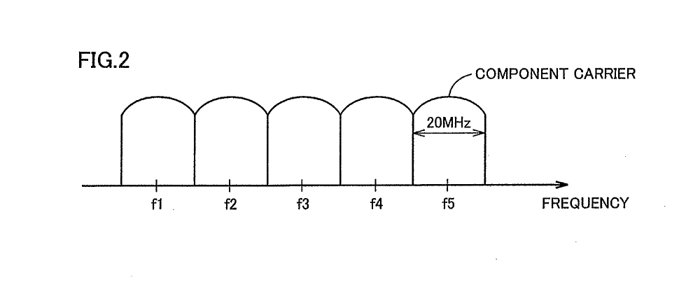

FIG. 2 schematically represents the concept of carrier aggregation. Referring to FIG. 2, carrier aggregation is the technique to enlarge the maximum transmission bandwidth that can be supported. Typically, the maximum transmission bandwidth of LTE (20 MHz by way of example) is enlarged up to 100 MHz. Specifically, a plurality of component carriers corresponding to the maximum transmission bandwidth of LTE are used to carry out data transmission and reception with UE.

By way of example, as shown in FIG. 2, a plurality of frequency bands each centered about a different frequency (f1, f2, . . . , f5) are set. One or more frequency bands used for communication are selected from the set frequency bands according to the status. In other words, a HeNB can selectively use at least one of a plurality of frequency bands to communicate with a mobile terminal (UE).

By utilizing the concept of carrier aggregation, backward compatibility with LTE can be maintained.

As will be described afterwards, the UE according to the present embodiment can suitably generate a proximity indication that is notified at the time of handover to a base station mounted with such a carrier aggregation function.

<3. Handover Operation>

A handover operation envisaged at the current stage will be described hereinafter. In the description of the handover operation, the eNB or HeNB currently connected in communication with UE prior to initiating a handover operation is referred to as “source eNB” or “source HeNB”, whereas the HeNB selected as the handover destination by UE is referred to as “target HeNB”.

According to the approach disclosed in the aforementioned NPD1, in the case where a handover operation to any HeNB is initiated when UE is currently connected in communication with a serving cell (source eNB), a proximity indication is notified from UE to the eNB currently connected in communication when (i) UE determines that a HeNB having identification information identical to any of CSG_IDs described in the allowed CSG list maintained at the host station is located nearby, or when (ii) UE determines exit from the nearby area of a HeNB.

Consider the case where a message and corresponding frequency information are included in “enter” indicating approach to a HeNB having identification information identical to any CSG_ID described in the allowed CSG list retained by UE. When source eNB receives the relevant proximity indication in this case, a handover process to the HeNB (or a preparation process therefor) is initiated for the corresponding UE. In this handover processing, S1 interface or X2 interface is used.

In the present embodiment, consider the case where UE 500 in a connecting state with eNB 300-1 that is a serving cell enters a proximity area of HeNB 100. In this case, UE 500 notifies eNB 300-1 that is the serving cell about the proximity indication including an “enter” message.

It is assumed that HeNB 100 is based on a CSG cell or hybrid cell, having a CSG-ID that is assigned to this cell in the allowed CSG list retained by UE 500.

As described above, HeNB 100 of FIG. 1 supports carrier aggregation. In carrier aggregation, each of a plurality of component carriers used therefor is handled as a virtual cell. Specifically, HeNB 100 shown in FIG. 1 includes component carriers corresponding to frequency bands of frequency f1, f2 . . . fn, having a cell attribute (CSG cell or hybrid cell) and CSG-ID set independently for each component carrier.

Corresponding to the configuration shown in FIG. 1 under the current standard, a plurality of proximity indications will be transmitted to the serving cell for every frequency band with respect to the plurality of cells (component carrier) associated with each of the frequency bands provided by HeNB 100. This induces the event of the radio resource of the network being consumed in waste.

When handover from the serving cell to HeNB 100 is required in the present embodiment, the serving cell is notified about the proximity indication associated with not all the frequency bands, but only some of the frequency bands from a plurality of frequency bands (component carrier) used by HeNB 100 for communication, based on information such as the connection history in the past. Accordingly, the event of the network radio resource being consumed in waste can be avoided.

<4. Mobile Terminal (UE) Configuration>

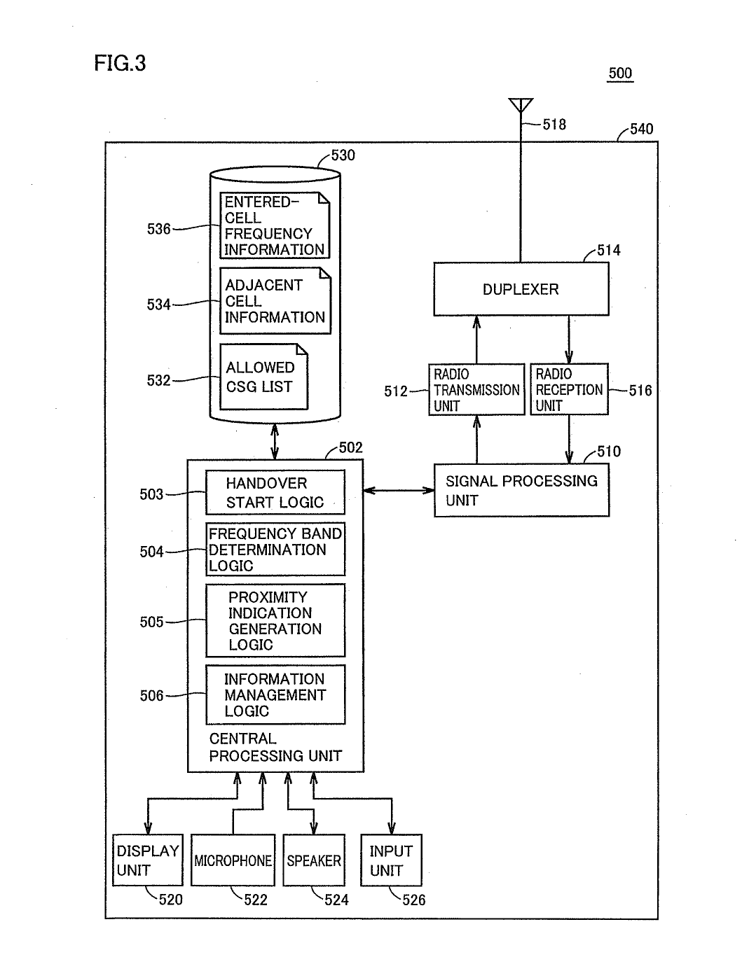

A configuration of a mobile terminal used in communication system SYS according to the first embodiment of the present invention will be described hereinafter. FIG. 3 is a block diagram of mobile terminal (UE) 500 used in communication system SYS according to the first embodiment of the present invention.

Referring to FIG. 3, UE 500 includes a casing 540 where a transmission/reception antenna 518 to transmit and receive a radio signal is provided. Casing 540 includes a central processing unit 502, a signal processing unit 510, a storage unit 530, a radio transmission unit 512, a duplexer 514, and a radio reception unit 516.

Central processing unit 502 includes, as the main constituent elements, a processor, a non-volatile memory for storing a program executed by the processor, and a volatile memory functioning as a work memory. Central processing unit 502 further includes a handover start determination logic 503, a frequency band determination logic 504, a proximity indication generation logic 505, and an information management logic 506. These logics are typically presented by central processing unit 502 executing a program. For example, a module corresponding to each logic is stored in advance in a non-volatile memory. By central processing unit 502 reading out these modules for execution, the functions that will be described afterwards are provided.

Handover start determination logic 503 determines whether handover is requested or not based on information from a serving cell provided via signal processing unit 510.

Frequency band determination logic 504 determines, when handover from a base station of the serving cell (source eNB) to a target HeNB is required during communication-connection with the serving cell, some of the plurality of frequency bands supported by the HeNB as the frequency band to be associated with the proximity indication based on stored information of the frequency band used in a previous communication. Namely, at the time of handover to the HeNB supporting carrier aggregation, a proximity indication is notified associated with a frequency band (cell) having a higher possibility of being used, instead of notifying a proximity indication for all the frequency bands (all cells) supported by the relevant HeNB. Details of the processing by frequency band determination logic 504 will be described afterwards.

Proximity indication generation logic 505 generates the proximity indication to be sent to the source HeNB according to the determination result and the like by frequency band determination logic 504.

Information management logic 506 causes storage unit 530 to store, by each base station basis, the frequency band used for communication from the plurality of frequency bands. In other words, information management logic 506 monitors the information and the like used for determination at frequency band determination logic 504. More specifically, information management logic 506 carries out update processing and the like for each type of information retained in storage unit 530 according to the state of communication with a base station or the like. The details of the management processing by information management logic 506 will be described afterwards.

Storage unit 530 is typically formed of a non-volatile memory such as a flash memory, and includes an allowed CSG list 532, adjacent cell information 534, and entered-cell frequency information 536.

In allowed CSG list 532 is described cell identification information (CSG_ID) of the HeNB that has connection by the host UE allowed. This identification information (CSG_ID) is referred to by central processing unit 502.

Adjacent cell information 534 includes the information of the frequency band that can be used in the cell (CSG cell or hybrid cell) having identification information described in allowed CSG list 532.

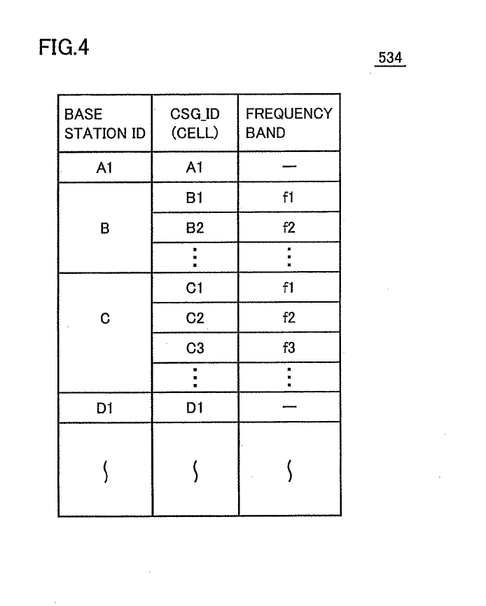

FIG. 4 represents an example of adjacent cell information 534 retained by mobile terminal 500 according to the first embodiment of the present invention. Referring to FIG. 4, adjacent cell information 534 includes the identification information (CSG_ID) of each cell provided by each base station, stored in association with the identification information of a corresponding base station (base station ID). In the example of FIG. 4, base stations having the base station IDs of “B” and “C” support carrier aggregation. Since each component carrier corresponds to a “cell”, unique identification information (CSG_ID) is set for each component carrier. Adjacent cell information 534 has a frequency band (frequency information) described in association with each cell.

Adjacent cell information 534 may be updated by a notification from the base station. Alternatively, adjacent cell information 534 may be updated dynamically according to a connection history of UE 500 or the like.

Entered-cell frequency information 536 includes frequency information related to any cell (CSG cell or hybrid cell) where UE 500 has entered.

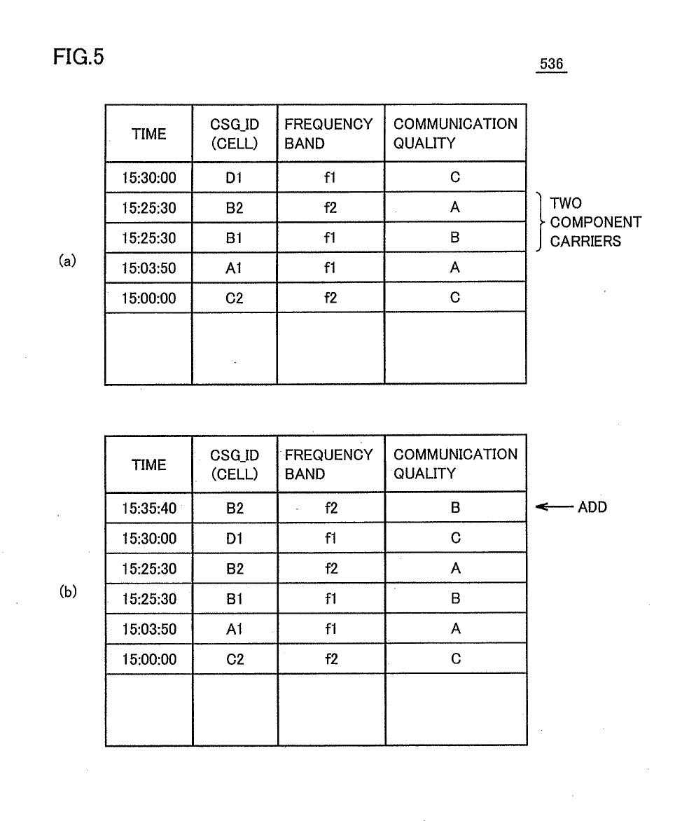

FIG. 5 represents an example of entered-cell frequency information 536 retained by mobile terminal 500 according to the first embodiment. Referring to FIG. 5, entered-cell frequency information 536 includes identification information (CSG_ID) indicating any cell that has been connected in communication with UE 500 from the past, stored in time series in association with time information. Namely, information management logic 506 stores information of the frequency band used for communication in association with time.

At that stage, information of the used frequency band and the communication quality are also stored in association, with regards to each communication-connection. Namely, information management logic 506 stores information of a frequency band used for communication in association with the communication quality at the time of that communication.

Since identification information (CSG_ID) unique to each component carrier is assigned in carrier aggregation, a plurality of entries will be stored in association with substantially the same date in the case where communication with a base station is carried out using a plurality of component carriers.

For entered-cell frequency information 536, the information is stacked at the timing of UE 500 newly entering the range of any entered-cell. For example, when UE 500 enters a cell having the identification information (CSG_ID) of “B2” under the state with entered-cell frequency information 536 as shown in FIG. 5(a), information is newly added to entered-cell frequency information 536, as shown in FIG. 5(b). In entered-cell frequency information 536, a more recent entry is handled with higher priority.

As used herein, the communication quality is determined according to the intensity of the radio signal indicated as a reference signal received power (RSRP), the bit error rate and the like of each frequency band.

Signal processing unit 510 processes a radio signal communicated with a base station monitoring the cell range where the host UE is present. More specifically, signal processing unit 510 outputs to radio transmission unit 512 the information to be transmitted to the base station, according to an internal command provided from central processing unit 502 or the like. Radio transmission unit 512 carries out encoding and modulation on the information received from signal processing unit 510, and then outputs the resultant radio signal to duplexer 514. Radio reception unit 516 carries out demodulation and decoding on the radio signal received via duplexer 14, and outputs the resultant information to signal processing unit 510. Duplexer 514 is connected to transmission/reception antenna 518 to separate transmitted and received radio signals. Namely, duplexer 514 outputs the radio signal applied from radio transmission unit 512 to transmission/reception antenna 518, and outputs the radio signal applied from transmission/reception antenna 518 to radio reception unit 516.

The function provided by central processing unit 502 may be partially or entirely implemented as dedicated hardware (integrated circuit). In this case, the functions provided by signal processing unit 510, radio transmission unit 512, and radio reception unit 516 may be entirely or partially implemented as one chip, in addition to the function provided by central processing unit 502. Moreover, a SoC (System On a Chip) having components such as a processor, memory, controller for a peripheral device implemented as one chip may be employed.

As an alternative configuration, the functions provided by signal processing unit 510, radio transmission unit 512 and radio reception unit 516 may be implemented entirely or partially by software. In this case, a functional device (processor) such as a CPU (Central Processing Unit) and DSP (Digital Signal Processor) will execute a set of commands installed in advance.

Referring to FIG. 3 again, casing 540 further includes a display unit 520 to display various information, a microphone 522 to obtain the voice of a user and the like, a speaker 524 to play the received voice, and an input unit 526 to accept a user's manipulation. These members are typically arranged to be exposed at casing 540,

<5. Base Station (HeNB, eNB) Configuration>

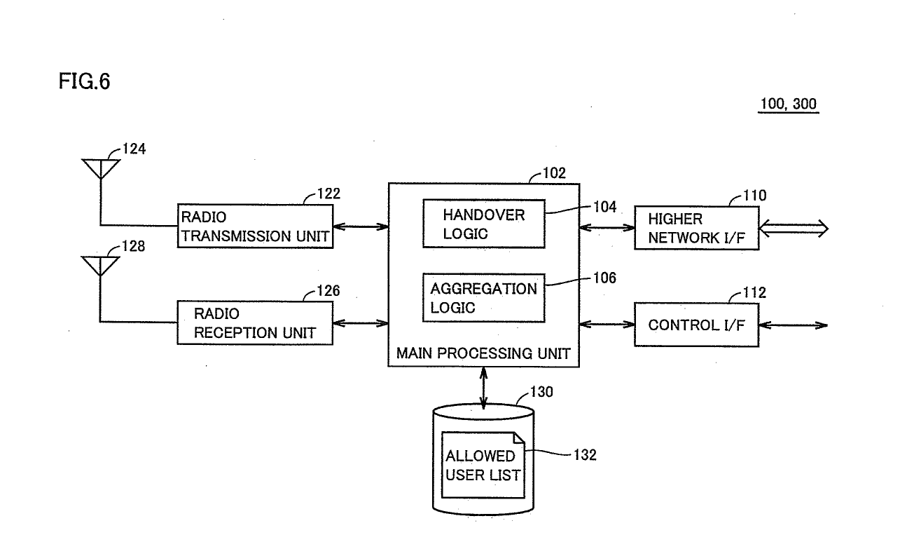

A configuration of a base station used in communication system SYS according to the first embodiment will be described hereinafter. FIG. 6 is a block diagram of a base station used in communication system SYS according to the first embodiment of the present invention.

Referring to FIG. 6, HeNB 100 includes a central processing unit 102, a storage unit 130, a radio transmission unit 122, a transmission antenna 124, a radio reception unit 126, a reception antenna 128, a higher network interface (I/F) 110, and a control interface (I/F) 112.

Central processing unit 102 includes, as the main constituent elements, a processor, a non-volatile memory for storing a program executed by the processor, and a volatile memory functioning as a work memory. Central processing unit 102 further includes a handover logic 104, and an aggregation logic 106. These logics are typically provided by central processing unit 102 executing a program. For example, a module corresponding to each logic is prestored in a non-volatile memory, and the function that will be described afterwards is provided by central processing unit 102 reading out and executing a relevant module.

Handover logic 104 performs handover with at least one another base station. More specifically, handover logic 104 responds to reception of a proximity indication notified from UE 500 to initiate handover with at least one another base station (HeNB or eNB). Since the proximity indication is notified in association with a specific cell, as set forth above, handover logic 104 executes a handover operation for only a cell associated with the proximity indication among the plurality of cells (frequency bands) supported by the corresponding base station.

Aggregation logic 106 determines which of the plurality of component carriers is to be allocated to UE 500 carrying out communication. The number of component carriers used for communication may be modified dynamically according to the communication status or the like.

Storage unit 130 stores an allowed user list 132 describing the identification information of a user permitting connection to the host station. In the case where the host station provides a CSG cell or hybrid cell, central processing unit 102 authorizes the identification information of UE 500 that is requesting connection, based on allowed user list 132. Connection to the host station by the relevant UE 500 is permitted only when authorization is granted.

Allowed user list 132 will be required when a HeNB provides a CSG cell or hybrid cell. Accordingly, allowed user list 132 is not required for a HeNB that provides only an open cell, or for an eNB.

Radio transmission unit 122 is connected with transmission antenna 124 to generate a radio signal according to user data and/or control data received from central processing unit 102, and emits the radio signal from transmission antenna 124. User data implies data transferred between UE 500 and a destination party (or relay destination).

Radio reception unit 126 demodulates a radio signal received from UE 500 via reception antenna 128 into user data and/or control data, and outputs the demodulated data to central processing unit 102.

Superior network interface 110 transmits and receives user data, control information, and management information to and from a gateway controlling the host station. Similarly, control interface 112 transmits and receives control information to and from another base station.

NB 300 has a configuration similar to that shown in FIG. 6. Therefore, details thereof will not be repeated.

<6. Overview of Selection Processing>

The overview of the processing to select a frequency band in association with a proximity indication will be described hereinafter.

In a handover mode to a base station supporting carrier aggregation, central processing unit 502 shown in FIG. 3 (frequency band determination logic 504) refers to entered-cell frequency information 536 to determine a frequency band having a higher priority as the frequency band to be used for communication. Specifically, central processing unit 502 (frequency band determination logic 504) selects a frequency band used in a relatively recent communication among the communication between UE 500 and the base station, and associates the selected frequency band with the proximity indication.

It is to be noted that, in the case where UE 500 communicates with a base station using a plurality of frequency bands as shown in FIG. 5(a), a frequency band having a higher communication quality is taken as a frequency band of higher priority. Namely, central processing unit 502 (frequency band determination logic 504) selects a frequency band having a relatively higher communication quality among the frequency bands used in the communication between UE 500 and the base station, and associates the selected frequency band with the proximity indication. In other words, a frequency band having a higher communication quality is selected in priority.

For a cell having connection permitted in adjacent cell information 534, but that has not been previously connected with UE 500, there is no entry (history) related to the relevant cell in entered-cell frequency information 536. In this case, central processing unit 502 (frequency band determination logic 504) randomly selects a cell (frequency band) to be connected from connectable cells described in adjacent cell information 534, and associates the selected cell with the proximity indication.

Specific procedures for the selection processing will be described hereinafter.

<7. Processing Procedure>

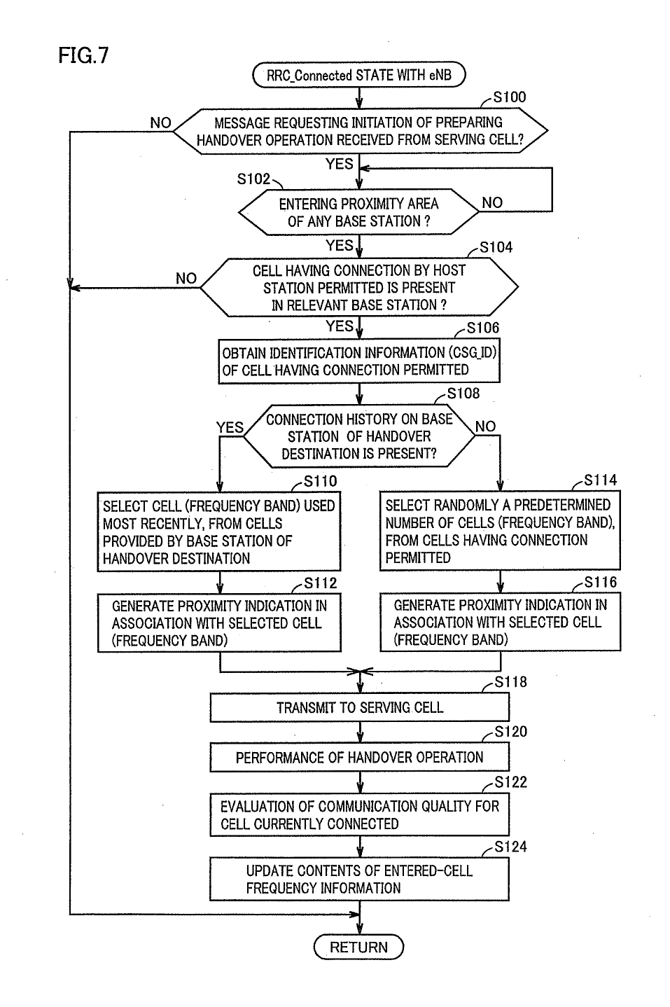

FIG. 7 is a flowchart of the processing procedure at a mobile terminal (UE) used in communication system SYS according to the first embodiment of the present invention. FIG. 7 corresponds to the case where UE 500 is in the RRC_Connected state with eNB 300-1 that is the serving cell.

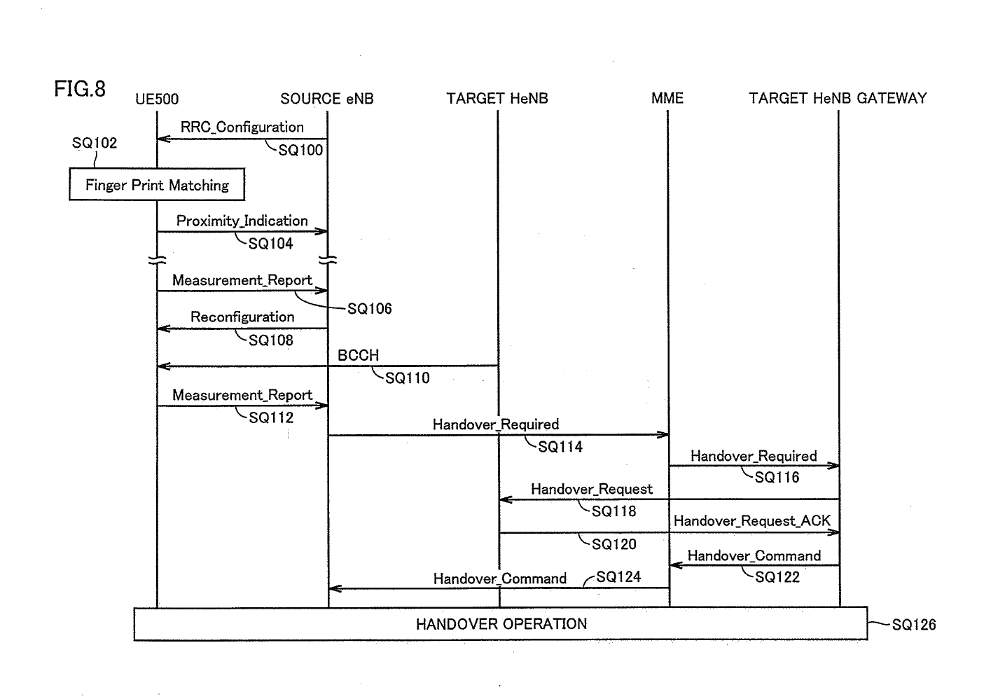

Referring to FIG. 7, central processing unit 502 of UE 500 (handover start determination logic 503 shown in FIG. 3) determines whether a message requesting initiation of preparing a handover operation has been received from the base device (eNB 300-1) of the serving cell (step S100). Specifically, a determination is made as to whether an RRC_{—} Configuration message (refer to FIG. 8 described afterwards) has been notified or not from the eNB that is currently connected in communication. When a message requesting initiation of preparing a handover operation has not been received from the base station (eNB 300-1) of the serving cell (NO at step S100), the processing returns.

In contrast, when a message requesting initiation of preparing a handover operation has been received from the base station (eNB 300-1) of the serving cell (YES at step S100), central processing unit 502 checks the radio wave environment in cooperation with signal processing unit 510 (FIG. 3) to search for a cell that may become a candidate of the handover destination present in the neighborhood. Then, central processing unit 502 sequentially executes a Finger_Print_Matching process (refer to FIG. 8 that will be described afterwards) to determine whether UE 500 has entered a proximity area of any base station (step S102).

When a detection is made that UE 500 has entered a proximity area of any base station (YES at step S102), central processing unit 502 (frequency band determination logic 504) refers to adjacent cell information 534 retained in storage unit 530 to determine whether there is a cell having connection by the host station permitted at the relevant base station (step S104). When a cell having connection by the host station permitted is not present in the relevant base station (NO at step S104), the processing returns.

In contrast, when a cell having connection by the host station permitted is present in the relevant base station (YES at step S104), central processing unit 502 (frequency band determination logic 504) obtains the identification information of the cell (CSG_ID) having connection permitted (step S106).

Then, central processing unit 502 (frequency band determination logic 504) refers to entered-cell frequency information 536 retained in storage unit 530 to determine whether there is a connection history on the base station of the handover destination using the identification information (CSG ID) obtained at step S106 (step S108).

When there is a connection history on the base station of the handover destination (YES at step S108), central processing unit 502 (frequency band determination logic 504) selects a most recent used cell (frequency band) from the cells provided by the base station of the handover destination (cells having connection permitted by the host station) (step S110). Specifically, a cell of a higher rank among the cells provided by the base station of the handover destination in entered-cell frequency information 536 as shown in FIG. 5 is selected in priority.

Then, central processing unit 502 (proximity indication generation logic 505) generates a proximity indication in association with the cell (frequency band) selected at step S110 (step S112). Namely, a proximity indication is generated for every selected cell (frequency band).

The number of cells (frequency band) selected at step S110 may be only one cell corresponding to the most recent history (newest history), or all the cells (frequency band) connected up to date as far back as a predetermined period. In the case of such selection processing, a plurality of cells to be associated with the proximity indication may be selected. In this case, central processing unit 502 selects a cell having a higher communication quality in priority.

In the case where there is no connection history on the base station of the handover destination (NO at step S108), central processing unit 502 (frequency band determination logic 504) selects randomly a predetermined number of cells (frequency band) from connection-permitted cells described in adjacent cell information 534 (step S114). Then, central processing unit 502 (proximity indication generation logic 505) generates a proximity indication in association with the cell (frequency band) selected at step S114 (step S116).

Central processing unit 502 transmits the proximity indication generated at step S112 or S116 to eNB 300-1 that is the serving cell (step S118).

Then, central processing unit 502 performs a handover operation according to a predetermined procedure (S120). When the handover succeeds and the entering cell is modified, central processing unit 502 (information management logic 506) evaluates the communication quality for the currently connected cell (step S122), and updates the contents of entered-cell frequency information 536 (step S124). Then, the processing returns. Specifically, information of the cell belonging after the handover (the used frequency band and communication quality) is stacked in entered-cell frequency information 536.

<8. Communication Sequence>

The communication sequence involved in a handover operation will be described hereinafter. FIG. 8 represents the sequence of a handover operation at communication system SYS according to the first embodiment of the present invention.

Referring to FIG. 8, eNB 300-1 (source eNB) that is the serving cell of UE 500 notifies UE 500, when a determination is made that the communication quality with UE 500 has been degraded down to a predetermined level, about an RRC_Configuration (Radio Resource Control Configuration) message that will trigger a handover operation (sequence SQ100).

When UE 500 receives an RRC_Configuration message notified by eNB 300-1 via radio reception unit 516 (FIG. 3), UE 500 searches for a cell that will become a candidate of the handover destination present in the neighborhood. Specifically, UE 500 sequentially executes a Finger_Print_Matching process to determine whether a proximity area of another base station is entered or not (sequence SQ102).

When a determination is made of entering a proximity area of any base station (in this case, assumed to be HeNB 100), UE 500 notifies eNB 300-1 that is the serving cell about a Proximity_Indication message (proximity indication) including an “enter” message indicating that UE 500 has approached HeNB 100 (sequence SQ104). Upon receiving a proximity indication including an “enter” message, eNB 300-1 that is the source eNB (serving cell) can detect that UE 500 is approaching HeNB 100 that is the target HeNB. At this stage, eNB 300-1 initiates a handover process for only a cell associated with the received proximity indication from the plurality of cells supported by the target HeNB.

UE 500 notifies the proximity indication for only the frequency band (cell) selected by the aforementioned selection processing from the plurality of frequency bands (cell) supported by HeNB 100 that is the target HeNB.

Upon receiving the RRC_Reconfiguration message, UE 500 notifies eNB 300-1 that is the serving cell about a Measurement_Report message including the current reception state (the base station receiving a radio signal, communication quality, and the like) (sequence SQ106). Upon receiving a Measurement_Report message, eNB 300-1 notifies UE 500 about an RRC_ReConfiguration (Radio Resource Control Re_Configuration) message to collect information required for carrying out a handover operation (sequence SQ108).

Upon receiving a control message broadcasted through a BCCH (Broadcast Control Channel) from HeNB 100 that is the target HeNB(sequence SQ110), UE 500 notifies HeNB 100 that is the target HeNB again about a Measurement_Report message including the current reception state (the base station receiving a radio signal, communication quality, and the like) (sequence SQ112).

Upon receiving a Measurement_Report message, eNB 300-1 that is the source eNB notifies a control device (gateway or MME control device) capable of MME about a Handover required message (sequence SQ114). The control device capable of MME transfers the Handover required message received from eNB 300-1 to gateway 150 monitoring the target HeNB (sequence SQ116). Specifically, in response to reception of a Handover_Required message, that message is transmitted to gateway 150 monitoring HeNB 100 that is the target HeNB.

By receiving the Handover_Required message, gateway 150 starts the preparation of a handover operation. Specifically, gateway 150 notifies HeNB 100 that is the target HeNB about a Handover request message (sequence SQ118). Upon receiving this Handover_{—} request message, HeNB 100-1 that is the target HeNB initiates the preparation for a handover operation, and notifies gateway 150 about a Handover_Request_ACK (acknowledge) message (sequence SQ120).

Upon receiving this Handover_Request_ACK message, gateway 150 notifies the control device capable of MME about a Handover_Command message indicating initiation of handover operation (sequence SQ122). Upon receiving the Handover_Command message, the control device capable of MME notifies HeNB 100 that is the target HeNB about the Handover Command message (sequence SQ124).

Upon completing the series of procedure, a handover operation is performed (sequence SQ126).

<9. Advantage>

According to the communication system of the present embodiment, the mobile terminal (UE) notifies, when a handover process is to be performed for a base station that supports a plurality of frequency bands (cell), a proximity indication, not for all the frequency bands (cell) supported by the relevant base station, but only for some of the frequency bands. In other words, the proximity indication is notified only for a frequency band (cell) expected to have a relatively favorable radiowave environment at the area of each handover destination. Therefore, the possibility of shifting again to another frequency band subsequent to the handover (after entering the area) is low. Accordingly, a stable handover operation can be realized. At the same time, the consumed amount of the radio resource can be suppressed since the proximity indication is transmitted, not for all the frequency bands (cell), but for only some of the frequency bands. Therefore, wasteful consumption of the radio resource can be avoided. Furthermore, power consumption at the mobile terminal can be reduced since the number of proximity indications to be transmitted is fewer.

### Second Embodiment

The first embodiment was described based on a configuration in which a cell notifying a proximity indication is selected based on the connection history and connection quality. The second embodiment is based on a configuration in which priority is set and evaluated among a plurality of cells (frequency band) provided by the same base station, and selecting a cell based on the priority.

<1. System Configuration>

The configuration of a communication system SYS envisaged in the second embodiment of the present invention is similar to that of aforementioned communication system SYS of FIG. 1. Therefore, detailed description thereof will not be repeated.

<2. Mobile Terminal (UE) Configuration>

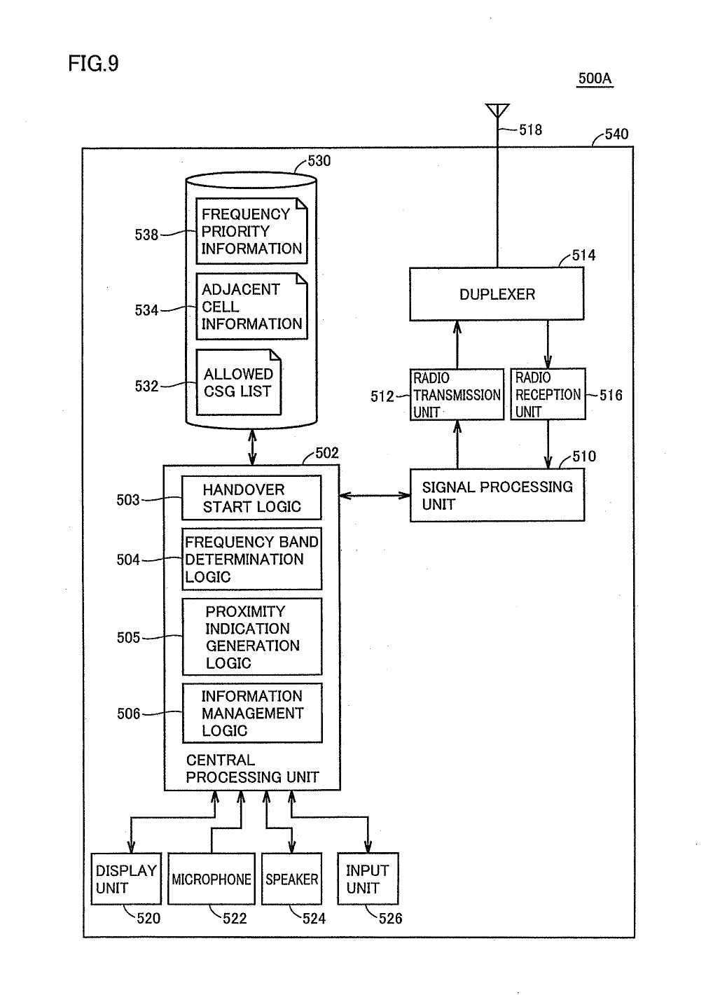

A configuration of a mobile terminal used in communication system SYS according to the second embodiment of the present invention will be described hereinafter. FIG. 9 is a block diagram of a mobile terminal (UE) 500A used in communication system SYS according to the second embodiment of the present invention.

Referring to FIG. 9, UE 500A differs from UE 500 of FIG. 3 in that the information stored in storage unit 530 differs. Storage unit 530 of UE 500A stores allowed CSG list 532 and adjacent cell information 534, likewise with UE 500 of FIG. 3, and stores frequency priority information 538 instead of entered-cell frequency information 536.

Since the information stored in storage unit 530 differs, the processing of frequency band determination logic 504 and information management logic 506 referring to the information differs from that of UE 500 according to the first embodiment in the issues set forth below.

The remaining configuration and processing are similar to those of UE 500 according to the first embodiment. Therefore, detailed description thereof will not be repeated. The following description is mainly focused on the difference from the first embodiment.

Frequency priority information 538 includes the level of priority for a frequency band that can be used at a cell (CSG cell or hybrid cell) having identification information (CSG_ID) described in allowed CSG list 532.

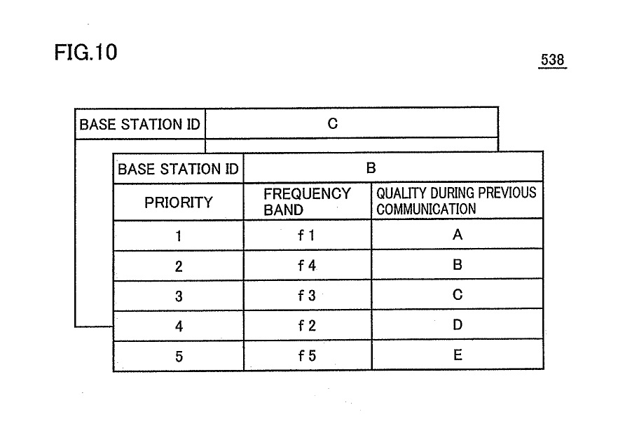

FIG. 10 shows an example of frequency priority information 538 retained by mobile terminal 500A according to a second embodiment of the present invention. Referring to FIG. 10, frequency priority information 538 includes the priority among frequency bands (cell) that can be used for every base station that has been connected in communication by UE 500A in the past, stored in association. Frequency priority information 538 has the base station establishing communication with mobile terminal 500A and the frequency band used for the communication stored in association with a corresponding priority.

Specifically, frequency priority information 538 has the communication quality (the quality of the previous communication) for each of provided frequency bands (cell) stored in association for every base station (base station ID) that has established communication with mobile terminal 500A in the past. The priority is determined based on the relative relationship between the evaluated communication qualities.

It is appreciated from FIG. 10 that the communication quality is evaluated as A, B, C, D and E in the descending order from higher quality, and a priority level is assigned along this order of communication quality.

Thus, central processing unit 502 (information management logic 506) determines the priority for a plurality of frequency bands that can be used at the base station having carried out communication, and information of the base station having carried out communication and the frequency band used for the communication are stored in association with a corresponding priority.

Likewise with the above-described first embodiment, the communication quality can be determined according to the intensity of the radio signal indicated as a reference signal received power (RSRP) of each frequency bands (cell), the bit rate, and the like. Upon connection with any cell, central processing unit 502 (information management logic 506) evaluates the communication quality at the relevant connected state, and updates the priority among the plurality of frequency bands (cell) provided by the corresponding base station based on the relevant evaluation. In other words, information management logic 506 determines the priority for a plurality of frequency bands that can be used at the base station having carried out communication. Therefore, for a base station, a higher priority is set for a frequency band having a higher communication quality during the previous communication among the supported frequency bands (cell). At this stage, information management logic 506 assigns a relatively higher priority to a frequency band having a relatively higher communication quality during a previous communication, and updates the priority when a new communication connection is established.

Frequency band determination logic 504 refers to frequency priority information 538 shown in FIG. 10 at the start of a handover operation to select a specific frequency band among the plurality of frequency bands (cell) provided by the HeNB of the handover destination (target HeNB). Specifically, frequency band determination logic 504 selects a frequency band having a relatively higher priority, and associates the selected frequency band with the proximity indication.

<3. Base Station (HeNB, eNB) Configuration>

The configuration of the base station used in communication system SYS according to the second embodiment of the present invention is similar to that of HeNB 100 shown in FIG. 6. Therefore, detailed description thereof will not be repeated.

<4. Overview of Selection Processing>

An overview of the selection processing of a frequency band associated with a proximity indication will be described hereinafter.

In a handover mode to a base station supporting carrier aggregation, central processing unit 502 shown in FIG. 9 (frequency band determination logic 504) refers to frequency priority information 538 to determine a frequency band having a higher priority as the frequency band to be used for communication. Specifically, central processing unit 502 selects one or more frequency bands (cell) having a higher priority among the frequency bands (cell) described in frequency priority information 538 shown in FIG. 10. Thus, central processing unit 502 (frequency band determination logic 504) associates a frequency band having a relatively higher priority with the proximity indication.

For a base station (cell) having connection permitted in adjacent cell information 534, but not previously connected with UE 500A, there is no entry (history) related to the cell provided by the relevant base station in frequency priority information 538. In this case, central processing unit 502 (frequency band determination logic 504) randomly selects a frequency band (cell) to be connected from cells provided by the base station of interest described in adjacent cell information 534.

Specific procedures for the selection processing will be described hereinafter.

<5. Processing Procedure>

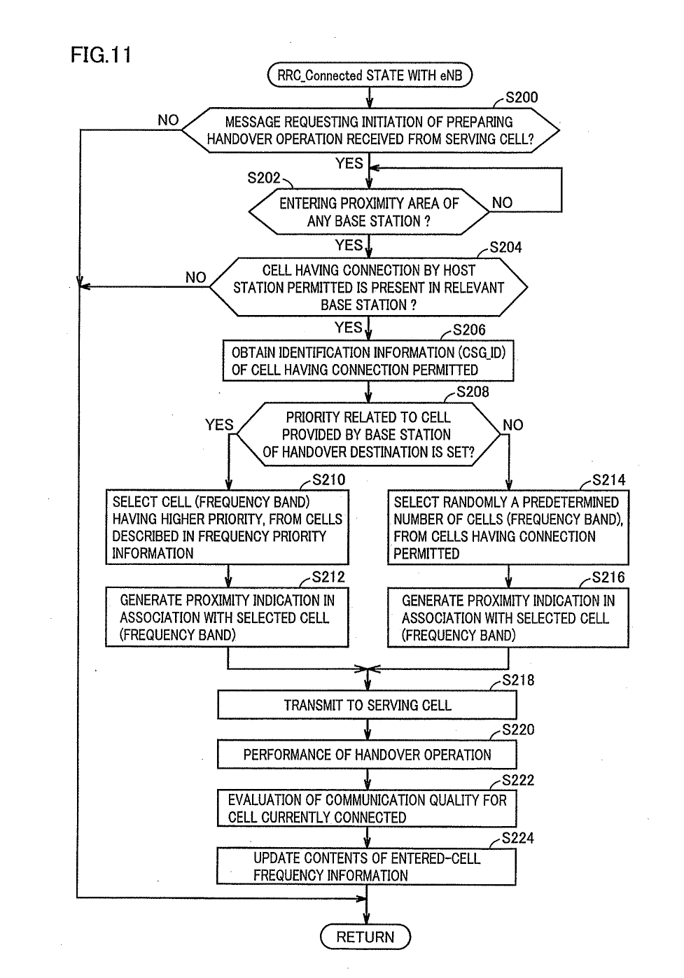

FIG. 11 is a flowchart of the processing procedure at a mobile terminal (UE) used in communication system SYS according to the second embodiment of the present invention. FIG. 11 corresponds to the case where UE 500A is in the RRC_Connected state with eNB 300-1 that is the serving cell.

Referring to FIG. 11, central processing unit 502 of UE 500A (handover start determination logic 503 shown in FIG. 9) determines whether a message requesting initiation of preparing a handover operation has been received from the base station (eNB 300-1) of the serving cell (step S200). Specifically, a determination is made as to whether an RRC_Configuration message (refer to FIG. 8 described above) has been notified or not from the HeNB that is currently connected in communication. When a message requesting initiation of preparing a handover operation has not been received from the base station (eNB 300-1) of the serving cell (NO at step S200), the processing returns.

In contrast, when a message requesting initiation of preparing a handover operation has been received from the base station (eNB 300-1) of the serving cell (YES at step S200), central processing unit 502 checks the radio wave environment in cooperation with signal processing unit 510 (FIG. 9) to search for a cell that may become a candidate of the handover destination present in the neighborhood. Then, central processing unit 502 sequentially executes a Finger_Print_Matching process (refer to FIG. 8 described above) to determine whether UE 500A has entered a proximity area of any base station (step S202).

When a detection is made that UE 500A has entered a proximity area of any base station (YES at step S202), central processing unit 502 (frequency band determination logic 504) refers to adjacent cell information 534 retained in storage unit 530 to determine whether there is a cell having connection by the host station permitted at the relevant base station (step S204). When a cell having connection by the host station permitted is not present in the relevant base station (NO at step S204), the processing returns.

In contrast, when a cell having connection by the host station permitted is present in the relevant base station (YES at step S204), central processing unit 502 (frequency band determination logic 504) obtains the identification information of the cell (CSG_ID) having connection permitted (step S206).

Then, central processing unit 502 (frequency band determination logic 504) refers to frequency priority information 538 retained in storage unit 530 to determine whether priority related to the cell provided by the base station of the handover destination is set using the identification information (CSG_ID) obtained at step S206 (step S208).

When the priority related to the cell provided by the base station of the handover destination is set (YES at step S208), central processing unit 502 (frequency band determination logic 504) selects a cell (frequency band) of higher priority among the cells described in frequency priority information 538 (step S210). Then, central processing unit 502 (proximity indication generation logic 505) generates a proximity indication in association with the cell (frequency band) selected at step S210 (step S212). Namely, a proximity indication is generated for every selected cell (frequency band).

The number of cells (frequency band) selected at step S210 may be only one cell of the highest priority, or a predetermined number of cells starting with a higher priority.

In the case where priority related to the cell provided by the base station of the handover destination is not set (NO at step S208), central processing unit 502 (frequency band determination logic 504) selects randomly a predetermined number of cells (frequency band) from connection-permitted cells described in adjacent cell information 534 (step S214). Then, central processing unit 502 (proximity indication generation logic 505) generates a proximity indication in association with the cell (frequency band) selected at step S214 (step S216).

Central processing unit 502 transmits the proximity indication generated at step S212 or S116 to eNB 300-1 that is the serving cell (step S218).

Then, central processing unit 502 performs a handover operation according to a predetermined procedure (S120). When the handover succeeds and the entering cell is modified, central processing unit 502 (information management logic 506) evaluates the communication quality for the currently connected cell (step S222), and updates the contents of frequency priority information 538 (step S224). Then, the processing returns. Specifically, based on the information of the cell belonging after the handover (the used frequency band and communication quality), update processing such as replacing the priority described in frequency priority information 538 is carried out (as necessary).

<6. Communication Sequence>

The communication sequence involved in a handover operation according to the second embodiment of the present invention is similar to that as shown in FIG. 8 set forth above. Therefore, detailed description thereof will not be repeated.

<7. Modification>

As described, a method of determining in advance the priority among cells (frequency band) provided by the same base station based on the communication quality evaluated in the previous communication history, and selecting a cell to be associated with the proximity indication has been exemplified.

As an alternative to, or in addition to such a method, the priority may be set taking into account a physical property or the like of a radiowave. For example, a radio signal has a frequency property of diffracting as the frequency becomes lower, so that transmission and reception can often be continued even when behind a building. Therefore, a relatively higher priority may be assigned to a cell having a relatively low frequency among a plurality of cells (frequency band) provided by the base station.

Furthermore, information related to priority may be externally applied with respect to a mobile terminal (UE). Specifically, the information related to priority may be set manually by a user or the like of the mobile terminal (UE), or sent from the base station to the mobile terminal (UE) during communication with the base station. In the former method, the priority is determined according to an operation external to the mobile terminal.

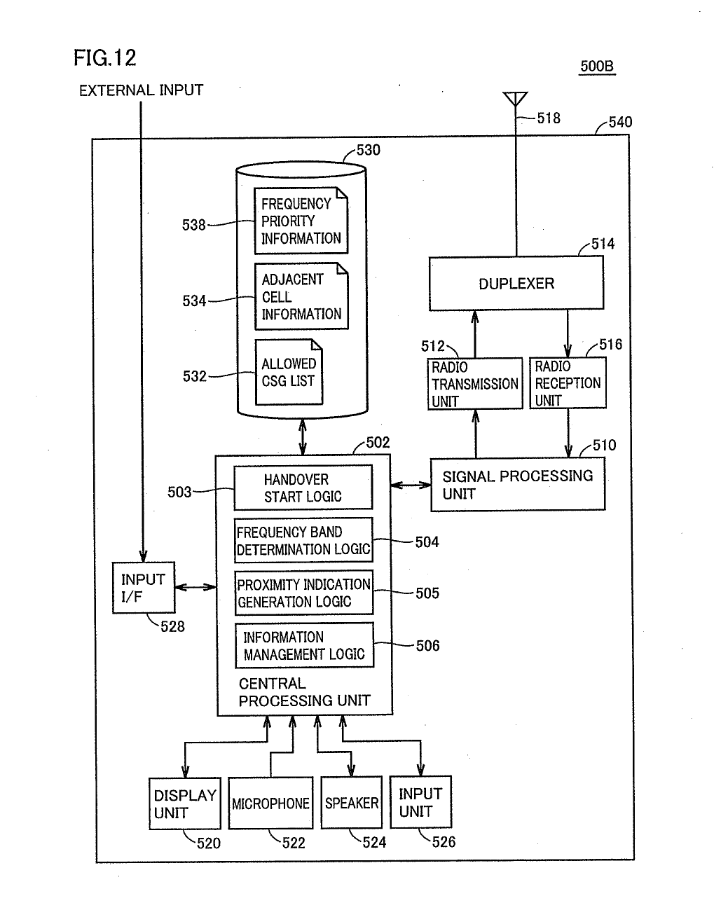

FIG. 12 is a block diagram of a mobile terminal (UE) 500B used in a communication system SYS according to a modification of the second embodiment of the present invention. In the case where information related to priority is to be provided from an external source of the mobile terminal (UE), as mentioned above, an input interface (I/F) 528 of mobile terminal 500B can be provided, as shown in FIG. 12.

Input interface 528 accepts a manipulation carried out by the operator of mobile terminal 500B, or accepts information related to priority sent from a base station.

At the base station, the communication quality with mobile terminal 500B is evaluated, and frequency priority information 538 as shown in FIG. 10 is set based on the relevant evaluation. This frequency priority information 538 is sent from the base station to mobile terminal 500B.

Thus, the present modification provides the function of a base station notifying mobile terminal 500B about information indicating the priority for a plurality of frequency bands that can be used at the relevant base station, and mobile terminal 500B transmitting a specific frequency band in association with the proximity indication based on the information indicating priority.

<8. Advantage>

According to the communication system of the present embodiment, the mobile terminal (UE) notifies, when a handover process is to be performed for a base station that supports a plurality of frequency bands (cell), a proximity indication, not for all the frequency bands (cell) supported by the relevant base station, but only for some of the frequency bands. In other words, the proximity indication is notified only for a frequency band (cell) having a relatively higher priority at the area of each handover destination. Therefore, the possibility of shifting again to another frequency band subsequent to the handover (after entering the area) is low. Accordingly, a stable handover operation can be realized. At the same time, the consumed amount of the radio resource can be suppressed since the proximity indication is transmitted, not for all the frequency bands (cell), but for only some of the frequency bands. Therefore, wasteful consumption of the radio resource can be avoided. Furthermore, power consumption at the mobile terminal can be reduced since the number of proximity indications to be transmitted is fewer.

### Other Embodiments

The configuration of the first embodiment and the configuration of the second embodiment and modification thereof described above may be combined appropriately.

Although the aforementioned first and second embodiments were described focusing mainly on an inbound handover operation to a home evolved node B (HeNB), the base station that is the subject of the present invention is not limited to a home evolved node B (HeNB). The present invention is applicable to a handover operation related to a base station of a general evolved type (eNB) or a base station of another type providing a macro cell.

It is to be understood that the embodiments disclosed herein are only by way of example, and not to be taken by way of limitation. The scope of the present invention is not limited by the description above, but rather by the terms of the appended claims, and is intended to include any modifications within the scope and meaning equivalent to the terms of the claims.

### REFERENCE SIGNS LIST

100 HeNB; 101C, 301C-303C cell range; 102, 502 central processing unit; 104 handover logic; 106 aggregation logic; 110 higher network interface; 112 control interface; 122, 512 radio transmission unit; 124 transmission antenna; 126, 516 radio reception unit; 128 reception antenna; 130, 530 storage unit; 132 allowed user list; 150, 350 gateway; 300 eNB; 400 core network; 500, 500A, 500B mobile terminal; 503 handover start determination logic; 504 frequency band determination logic; 505 proximity indication generation logic; 506 information management logic; 510 signal processing unit; 514 duplexer; 518 transmission/reception antenna; 520 display unit; 522 microphone; 524 speaker; 526 input unit; 528 input interface; 532 list; 534 adjacent cell information; 536 entered-cell frequency information; 538 frequency priority information; 540 casing; SYS communication system.

1. A wireless communication system comprising a mobile terminal and a plurality of base stations,
each of the base stations comprising:
a communication unit configured to selectively use at least one of a plurality of frequency bands to communicate with the mobile terminal; and
a handover unit configured to perform handover with at least one another base station, and
the mobile terminal comprising:
a storage unit configured to store, by each base station basis, information of a frequency band used for communication from the plurality of frequency bands; and
a notification unit configured to notify, when handover from a first base station currently connected in communication to a second base station is required, the first base station about a proximity indication associated with some of the plurality of frequency bands, based on the stored information of the frequency band used for communication, and
the handover unit is adapted to initiate handover based on the proximity indication from the mobile terminal.

2. The wireless communication system according to claim 1, wherein
the storage unit stores the information of the frequency band used for communication in association with time, and
the notification unit associates a frequency band used in a relatively recent communication among communication between the mobile terminal and the second base station with the proximity indication.

3. The wireless communication system according to claim 1, wherein
the storage unit stores the information of the frequency band used for communication in association with a communication quality during a relevant communication, and
the notification unit associates a frequency band having a relatively higher communication quality from frequency bands used for communication between the mobile terminal and the second base station with the proximity indication.

4. The wireless communication system according to claim 1, wherein
the storage unit determines priority for the plurality of frequency bands that can be used at a base station having carried out communication, and stores information of the base station having carried out communication and a frequency band used for the communication in association with a corresponding priority, and
the notification unit associates a frequency band having a relatively higher priority with the proximity indication.

5. The wireless communication system according to claim 1, wherein
the base station is configured to notify the mobile terminal about information indicating priority for a plurality of frequency bands that can be used at a relevant base station, and
the notification unit associates a particular frequency band with the proximity indication based on the information indicating the priority.

6. A mobile terminal used in a wireless communication system comprising a plurality of base stations adapted to selectively use at least one of a plurality of frequency bands to carry out communication, the mobile terminal comprising:
a storage unit configured to store, by each base station basis, information of a frequency band used for communication from the plurality of frequency bands, and
a notification unit configured to notify, when handover from a first base station currently connected in communication to a second base station is required, the first base station about a proximity indication associated with some of the plurality of frequency bands, based on stored information of the frequency band used for communication.

7. The mobile terminal according to claim 6, wherein
the storage unit stores information of a base station having carried out communication and a frequency band used for the communication in association with time, and
the notification unit associates a frequency band used in a relatively recent communication among communication between the mobile terminal and the second base station with the proximity indication.

8. The mobile terminal according to claim 6, wherein
the storage unit stores information of a base station having carried out communication and a frequency band used for the communication in association with a communication quality during a relevant communication, and
the notification unit associates a frequency band having a relatively higher communication quality, from frequency bands used for communication between the mobile terminal and the second base station, with the proximity indication.

9. The mobile terminal according to claim 6, wherein
the storage unit determines priority for a plurality of frequency bands that can be used at a base station having carried out communication, and stores the base station having carried out communication and a frequency band used for the communication in association with a corresponding priority, and
the notification unit associates a frequency band having a relatively higher priority with the proximity indication.

10. The mobile terminal according to claim 9, wherein the storage unit assigns a relatively higher priority to a frequency band having a relatively higher communication quality during a previous communication, and updates the priority when a new communication connection is established.

11. The mobile terminal according to claim 9, wherein the storage unit assigns a relatively higher priority to a frequency band having a relatively low frequency from a plurality of frequency bands.

12. The mobile terminal according to claim 9, wherein the storage unit determines the priority according to an operation external to the mobile terminal.

13. The mobile terminal according to claim 9, further comprising a reception unit configured to receive, from the base station, information indicating priority for a plurality of frequency bands that can be used at a relevant base station, and
the notification unit associates a particular frequency band with the proximity indication based on the information indicating the priority.

14. A communication method used at a wireless communication system comprising a plurality of base stations adapted to selectively use at least one of a plurality of frequency bands to carry out communication, the communication method comprising the steps of:
storing, by each base station basis, information of a frequency band used for communication from the plurality of the frequency bands, and
notifying, when handover from a first base station currently connected in communication to a second base station is required, the first base station about a proximity indication associated with some of the plurality of frequency bands, based on the stored information of a frequency band used for communication, and
initiating handover based on the proximity indication.

15. The mobile terminal according to claim 10, wherein the storage unit assigns a relatively higher priority to a frequency band having a relatively low frequency from a plurality of frequency bands.

16. The mobile terminal according to claim 10, wherein the storage unit determines the priority according to an operation external to the mobile terminal.
